(19) United States
(12) Patent Application Publication
(10) Pub. No.: US 2016/0055555 A1
(43) Pub. Date: Feb. 25, 2016

(54) Contextual and Holistic Credibility

(71) Applicant: Credibility Corp., Malibu, CA (US)

(72) Inventors: Brandon Mills, Redondo Beach, CA (US); Chad Michael Buechler, Los Angeles, CA (US); Jeffrey M. Stibel, Malibu, CA (US); Aaron B. Stibel, Malibu, CA (US)

(73) Assignee: Credibility Corp.

(21) Appl. No.: 14/464,939

(22) Filed: Aug. 21, 2014

(51) Int. Cl. G06Q 30/06; G06F 17/30

(52) U.S. Cl. CPC G06Q 30/0609; G06Q 30/0625; G06F 17/30882

(57) ABSTRACT

Some embodiments provide a credibility platform for a multi-dimensional, holistic, and real-time derivation and presentation of entity credibility. The holistic derivation of credibility is predicated on attributing context to subjective data using objective data. The credibility platform produces entity-specific context by identifying temporal or relational associations between different instances of target entity data. The credibility platform also produces comparative context for comparing the credibility of a target entity to a group of related entities. The credibility platform encourages entity engagement in order to provide a cause and effect presentation of credibility and to ensure real-time relevance of the derived credibility. To encourage participation, the platform prioritizes the presentation of credibility on the basis of entity engagement and provides fixed links to the credibility interfaces of the entities.

### TECHNICAL FIELD

The present invention pertains to entity credibility.

### BACKGROUND

Consumer decisions are guided in large part by credibility. Credibility is a holistic measure deriving from the prior experience that oneself and others have had with an entity. These experiences gauge different aspects of an entity and include anything from price, quality of goods and services, responsiveness, customer service, trustworthiness, stability, cleanliness, availability, etc.

The Internet has given rise to various social media sites, review aggregating sites, and rating aggregation sites. These sites act as a repository of user experiences. These sites allow anyone to tap into the collective experiences of others, and in so doing, allow anyone to learn about any entity without ever engaging with that entity or personally knowing anyone who has.

Yet even from several posts about the same target entity, one gains limited insight as to that entity's true credibility. This is because the experiences of others conveyed through the posts provide subjective data that is only part of the holistic measure of credibility. A true understanding of credibility comes from consideration of subjective data with objective data, whereby the objective data provides context to the subjective data.

Context explains the circumstances surrounding the sentiment that is expressed in the subjective data. In other words, context offers the cause to the effect described in the subjective data or, vice-versa, the effect to the cause that is described in the subjective data. As a simplistic example, subjective data may identify a first business having more negative reviews than a second business. However, context as provided by objective data, such as sales volume, can provide a deeper understanding of the credibility and explain that the reason the first business has more negative reviews is because it has three times the number of customers as the second business.

Another shortcoming of social media, review, and rating sites of the prior art is that they do not encourage engagement from the target entity, wherein the target entity is the entity whose credibility is the target of the subjective data (e.g., posts, reviews, and ratings). Usually, the target entity is the most knowledgeable point of contact about all aspects of itself. The target entity can provide the objective data needed to provide contextual reference to the subjective data. The target entity can also respond to issues identified in the experiences of others. In so doing, the target entity becomes not only a contributor to its own credibility, but contributes in a manner that provides an additional dimension to the credibility computation. Since most sites that provide a subjective view of credibility operate without active engagement from the target entity, the resulting credibility from these sites is again one dimensional and incomplete.

Yet another shortcoming is that some sites identify entity credibility without qualifying the credibility according to time. The time element is critical in ensuring the accuracy of the credibility being reported. It may be better to base a credibility decision using a site that has one review that is posted about a target entity in the last day, than using a site that has more reviews that were posted about the same target entity much further in the past (e.g., one month ago, one year ago, etc.). Yet, many prior art credibility sites ignore this time element. They simply present the credibility for those entities that most closely match user provided search criteria irrespective of whether their credibility is outdated, incomplete, or inaccurate. For example, when searching a review site for restaurants in a given geographic region, the first set of results commonly presented are those restaurants that are closest to the specified geographic region or that are most popular based on user feedback. Omitted from this presentation is consideration of when the last rating or review was received.

There is therefore a need to provide a holistic presentation of credibility. To do so, there is a need to provide context to subjective data. There is further a need to engage target entities in order to ensure accuracy of the resulting credibility and to ensure that reliable sources of subjective and objective data are involved in the credibility derivation. There is further a need to account for the timeliness and relevancy of the subjective and objective data involved in the credibility derivation.

### SUMMARY OF THE INVENTION

Some embodiments set forth a credibility platform. The credibility platform provides a multi-dimensional, holistic, and real-time derivation and presentation of entity credibility.

The multi-dimensional aspects of the credibility platform stem from interactivity and engagement with different sources of credibility contributors. The credibility platform incorporates subjective data and objective data for the holistic presentation of credibility.

The credibility platform sources the subjective data from the posts, articles, reviews, and ratings that are submitted by various third parties to various social media sites, review aggregation sites, rating aggregation sites, and other editorial or commentary sites. The subjective data may also be sourced directly from the target entities (i.e., those entities whose credibility is at issue). The subjective data captures the experiences of the third parties with various target entities and the responses of the target entities. The credibility platform sources the objective data from the target entities, trade references, credit reporting agencies, governmental databases, public financial records, and third party sites including news, regulatory, financial, and historic sites. The objective data relates to verified information or information that trusted or reliable sources disseminate about a target entity or different aspects of the target entity including the target entity's operation, identification, and performance.

From the collected subjective and objective data, the credibility platform holistically derives entity credibility in the form of scores or reports. In some embodiments, the holistic derivation of credibility is predicated in part on attributing context to the subjective data using the objective data. In some such embodiments, the credibility platform produces entity-specific context, whereby related subjective data about a specific target entity is associated or otherwise linked to related objective data about the same specific target entity. The entity-specific content may offer insight as to the objective data that is the cause for the effect expressed through the sentiment identified in some subjective data. Inversely, the entity-specific content may offer insight as to the objective data that results as an effect to the cause identified through the sentiment of some subjective data.

In some embodiments, the holistic derivation of credibility is predicated in part on the strength and confidence of the collected subjective and objective data. The credibility platform performs a strength assessment of the collected data for a target entity based on the depth of the collected data. The depth of the collected data is a measure of the number of data points collected for the target entity. If the credibility platform collects one five-star rating for a first target entity and several five-star ratings for a second target entity, the credibility platform increases the strength assessment for the data collected for the second target entity relative to the strength assessment for the data collected for the first target entity and, in turn, increases the resulting credibility of the second target entity relative to the first target entity based on the resulting strength assessments. The credibility platform performs the confidence assessment based on the reputation of the sources from which the data is collected and accuracy of the data. Data that is collected from trusted sources, such as public financial disclosures, are provided a higher confidence assessment than data that is collected from less reliable sources, such as unverified individuals. Similarly, when data that is collected from different sources matches, a higher confidence assessment results than if the data was mismatched. The resulting credibility of the target entity is then increased or decreased according to the confidence assessment. In this manner, strength and confidence contribute to the holistic derivation of credibility.

As part of the holistic derivation of credibility, some embodiments of the credibility platform produce comparative context to orient the credibility of a specific target entity relative to the credibility of a group of entities that is of interest. To do so, the credibility platform qualifies the group by identifying entities that meet user specified criteria. Next, the credibility platform processes the objective data of the group in order to produce collective metrics that can be compared to the objective data of a particular target entity. In so doing, the credibility of the target entity is explained relative to the target entity's standing within the group, thereby providing deeper insight as to how the credibility of the target entity compares to its peers beyond a simple credibility score or average rating comparison. From the comparative context, the credibility platform can also produce analytics and reports as to the health or performance of a given sector, region, or industry.

In some embodiments, the credibility platform prioritizes the presentation of credibility on the basis of entity engagement. Entity engagement is determined based on the number of profile updates or contributions and the recency of those updates or contributions. This promotes the engagement of the target entities. Entities will want to participant and provide credibility data to the credibility platform in order to improve their ranking in the search results, thereby increasing their exposure. As the target entities are a valuable source of credibility information and a primary means to produce change in their respective credibility, their active engagement serves to keep the credibility platform up-to-date and accurate. Moreover, the more engaged the targeted entities are, the faster they can address issues that are identified in the subjective data, thereby improving their own credibility. Third parties can also contribute to the entity engagement. For example, editors may update the profiles of various target entities to ensure that the information is correct and updated.

### BRIEF DESCRIPTION OF THE DRAWINGS

In order to achieve a better understanding of the nature of the present invention a preferred embodiment of the credibility platform will now be described, by way of example only, with reference to the accompanying drawings in which:

FIG. 1 presents an overview process generally describing operation of the credibility platform in accordance with some embodiments.

FIG. 2 conceptually illustrates creating an entity record for a particular entity in accordance with some embodiments.

FIG. 3 conceptually illustrates creating entity-specific context from temporal and relational similarities in subjective and objective data in accordance with some embodiments.

FIG. 4 presents a process for creating comparative context to supplement entity credibility in accordance with some embodiments.

FIG. 5 conceptually illustrates generating comparative context from current and historic reference data of a group in accordance with some embodiments.

FIG. 6 provides an introductory interface of the credibility platform.

FIG. 7 illustrates an interface that is presented in response to a user selection of a particular industry classification and geographic region.

FIG. 8 illustrates an interface provided by the credibility platform for holistically presenting the credibility of a particular target entity.

FIG. 9 presents an interface illustrating the prioritized presentation of credibility based on entity engagement in accordance with some embodiments.

FIG. 10 illustrates a computer system with which some embodiments are implemented.

### DETAILED DESCRIPTION OF THE INVENTION

In the following detailed description, numerous details, examples, and embodiments for systems and methods of a credibility platform are set forth and described. As one skilled in the art would understand in light of the present description, the systems and methods are not limited to the embodiments set forth, and the system and methods may be practiced without some of the specific details and examples discussed. Also, reference is made to accompanying figures, which illustrate specific embodiments in which the invention can be practiced. It is to be understood that other embodiments can be used and structural changes can be made without departing from the scope of the embodiments herein described.

### I. Overview

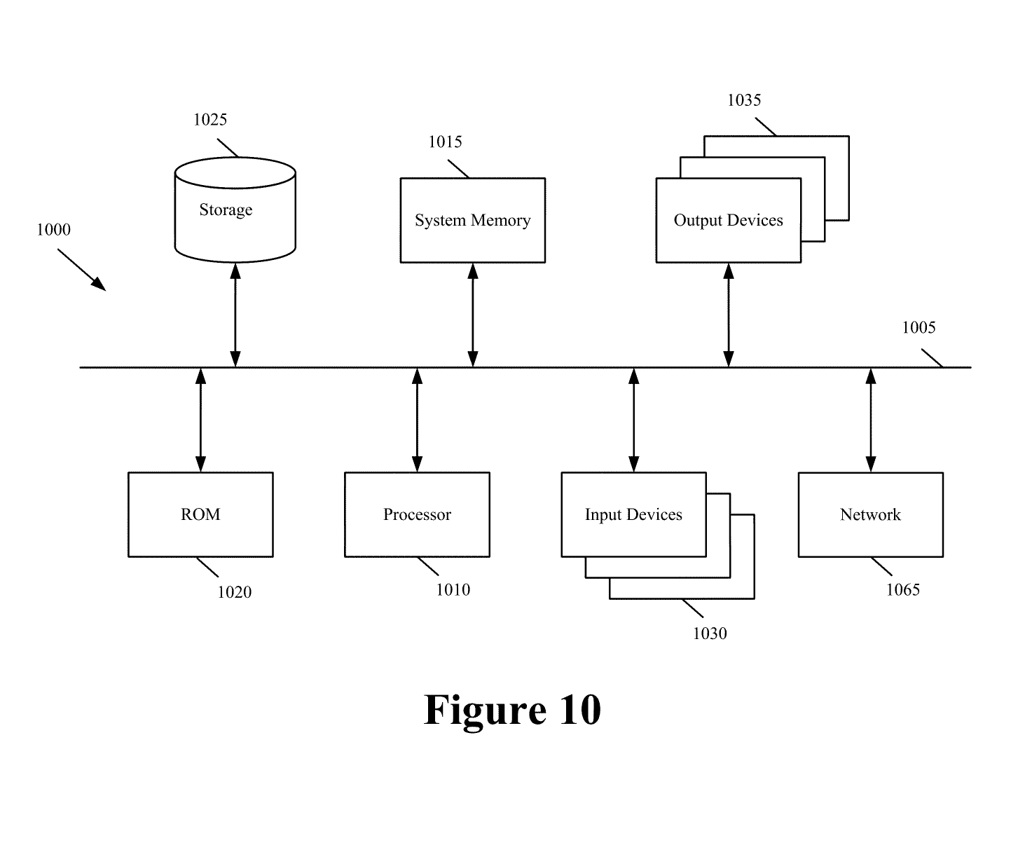

In some embodiments, the credibility platform is implemented using one or more machines. The implementation may involve software modules that are stored to non-transitory computer-readable media and that are executed by one or more processors of the machines. FIG. 10 and the corresponding disclosure below describe the machines with which the credibility platform of some embodiments is implemented.

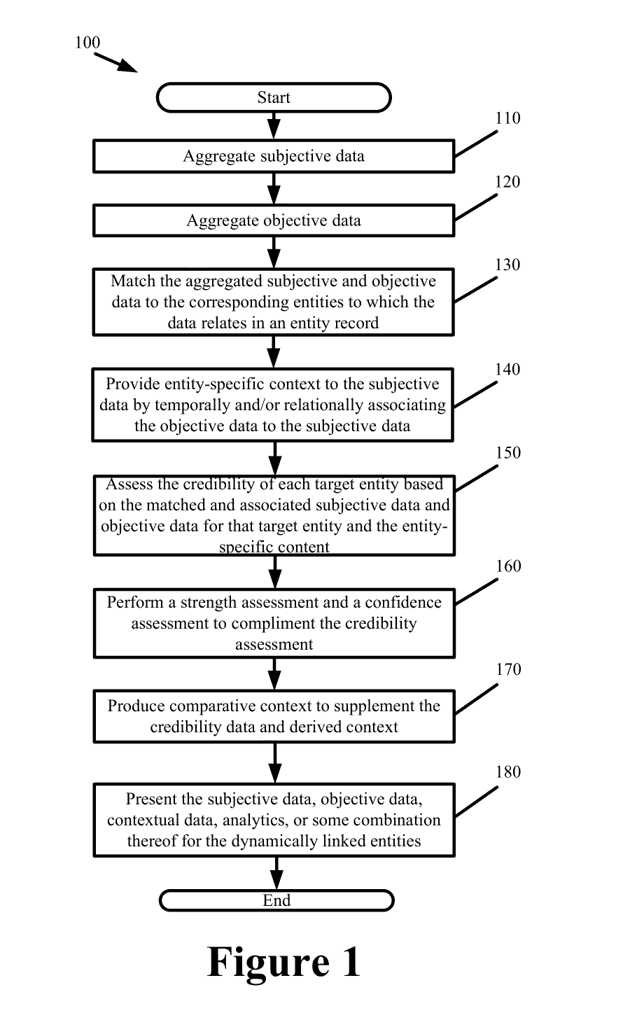

FIG. 1 presents an overview process 100 generally describing operation of the credibility platform in accordance with some embodiments. The process 100 commences by aggregating (at 110) subjective data from various data sources. Subjective data includes posts or messages that express sentiment about a target entity or various aspects relating to the target entity including the target entity's operation, identification, and performance. The subjective data includes reviews and ratings that various third parties post about their experiences with various target entities. The subjective data can also include Facebook messages and Twitter tweets as well as editorial or commentary published online. In preferred embodiments, a target entity is a business or individual to which subjective and objective data is directed. In some other embodiments, the target entity may be a good or service. The credibility platform aggregates the subjective data from different online sites and databases including review and rating aggregation sites, such as Yelp and CitySearch, social media sites, such as Facebook, and news sites, such as CNN. The credibility platform can also aggregate the subjective data directly from the data originators or those individuals that create and publish the messages or posts that comprise the subjective data.

The process supplements the subjective data by also aggregating (at 120) objective data. Whereas the subjective data relates to an opinion or personal experience, the objective data is verified information or information that trusted or reliable sources disseminate about a target entity or different aspects of the target entity including the target entity's operation, identification, and performance. Objective data relating to a target entity's operation can include historical information such as when specific events or occurrences took place. For example, objective data relating to a target entity's operation can identify when a new good or service was released or when a change was made to a menu, personnel, or goods supplier. Objective data relating to a target entity's identification can specify the name, contact information, location(s), industry classification, number of locations, number of employees, key employees, years in business, etc. of the target entity. Such objective data can also provide identifying information about other businesses and individuals associated with the target entity. Objective data relating to a target entity's performance can specify the target entity's revenue, profits, and outstanding debt as some examples. The credibility platform aggregates the objective data from data sources including the target entities, trade references, credit reporting agencies, governmental databases, public financial records, and third party sites including news, regulatory, financial, and historic sites.

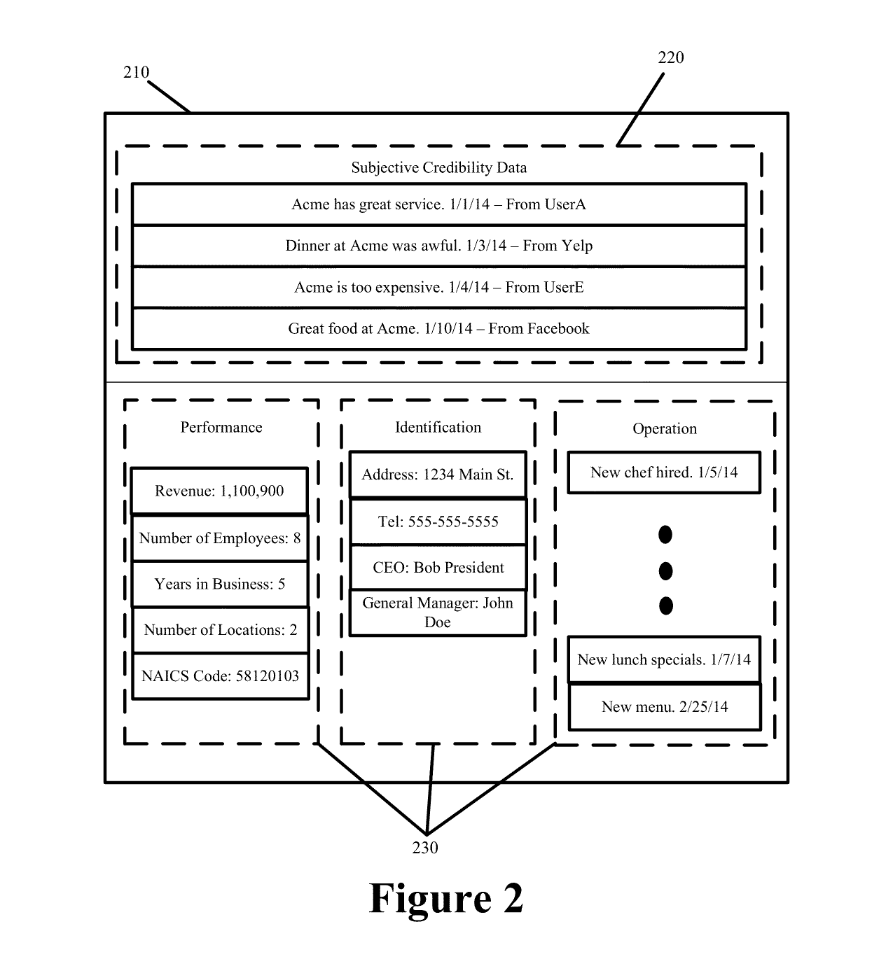

Next, the process matches (at 130) the aggregated data to the corresponding entities to which the data relates. In so doing, the credibility platform creates entity records for the various target entities. Each entity record stores the aggregated subjective data and the objective data for one specific entity. FIG. 2 conceptually illustrates creating an entity record 210 for a particular entity in accordance with some embodiments. As shown, the entity record 210 is populated with subjective data 220 that is aggregated from various subjective data sources and objective data 230 that is aggregated from various objective data sources. The credibility platform of some embodiments will store several thousand such entity records to a database.

At this stage, the credibility platform differentiates itself from other credibility reporting sites and services. The credibility platform does so by adding intelligence to the subjective and objective data it aggregates. The intelligence stems from identifying the contextual relevance between the different credibility data sets. Specifically, the process identifies (at 140) temporal and/or relational associations between the objective data and the subjective data of a given entity record with the identified associations producing entity-specific context. Such entity-specific context offers greater insight to credibility than when viewing the aggregated subjective data without a reference point. The entity-specific context reveals the causal effect behind the credibility, wherein the causal effect details changes or actions that caused a particular credibility state or changes or actions that are the consequence of a particular credibility state. For example, several recently aggregated reviews may complain about long lines at a target entity and the entity-specific context can reveal that the target entity has experienced a recent surge in popularity and is in the midst of expansion to remedy the issues.

The process then assesses (at 150) the credibility of each target entity based on the matched and associated subjective data and objective data for that target entity and the entity-specific content. In some embodiments, the credibility assessment produces a score to quantify the overall credibility of each target entity. In some embodiments, scores can also be produced to quantify the subjective and objective data components of the target entity's credibility. The score(s) can be alphanumeric, symbolic, or some combination of both.

In some embodiments, the credibility assessment involves quantifying the subjective data that is collected for a given target entity based on the sentiment expressed therein and any relevant entity-specific context from the objective data or related subjective data that is collected for that target entity. For example, subjective data stating “best prices” increases credibility of the target entity, while subjective data stating “worst service” decreases credibility of the target entity. However, the entity-specific context can reveal that the number of employees has increased since the “worst service” subjective data, and based on this entity-specific content, the credibility platform increases the target entity credibility to reflect the remedial action taken by the target entity. Similarly, in some embodiments, the credibility assessment involves quantifying the objective data that is collected for a given target entity based on the corresponding objective data values and any relevant entity-specific content from the subjective data or related objective data that is collected for that target entity. For example, objective data indicating revenue of ten million for a target entity having ten employees increases credibility of the target entity, whereas objective data indicating revenue of one million and debt of one million decreases credibility of the target entity. However, the entity-specific context can reveal that prospects for the target entity with one million in debt are substantially improving of late based on a disproportionate number of recent positive subjective data. As a result of the entity-specific content, the process increases the target entity's credibility.

The process also performs (at 160) a strength assessment and a confidence assessment to compliment the credibility assessment. The strength and confidence assessments are part of the holistic derivation of credibility and serve to verify the veracity and verbosity of the credibility assessment. The strength and confidence assessments may be integrated into the credibility assessment or may be separate scores that are representing alphanumerically, symbolically, or through some combination of both.

In some embodiments, the strength assessment identifies the depth of the collected data used in assessing the target entity's credibility. The depth of the collected data is a measure of the number of data points collected for the target entity and is indicative of the accuracy of the credibility assessment. The greater the amount of subjective data and objective data on which the credibility assessment is based, the more accurate the resulting credibility assessment will be which is indicated through the strength assessment. For example, if the credibility platform collects one five-star rating for a first target entity and several five-star ratings for a second target entity, the credibility platform attributes a greater strength assessment to the credibility of the second target entity than the first target entity, even though the credibility for both the second target entity and the first target entity is assessed to be the same.

In some embodiments, the strength assessment is qualified using the objective data collected for the target entity. Some examples of objective data on which the strength assessment can be qualified include the number of employees, revenue, years in business, number of locations, or any combination thereof. For example, the depth of data for a first target entity having one hundred employees and ten locations is expected to be greater than for a second target entity having ten employees and one location. In this example, the credibility platform may provide the same strength assessment for the first and second target entities when the depth of collected data for the first target entity is ten times greater than the depth of collected data for the second target entity. The strength assessment can be conveyed differently in different embodiments. For example, a score “A” can be indicative of an excellent credibility assessment but poor strength assessment, whereas a score “BBB” can be indicative of a very good credibility assessment and excellent strength assessment.

In some embodiments, the confidence assessment identifies the value of the collected subjective and objective data for a given target entity. The confidence assessment is based on the reputation or trustworthiness of the sources from which the data is collected and whether the data matches from different sources matches or is verified. Data that is collected from trusted sources, such as public financial disclosures, are provided a higher confidence assessment than data that is collected from less reliable sources, such as unverified individuals, as the data coming from the trusted source is more likely to be truthful and accurate than data coming from less reliable sources. Similarly, when data is collected from different sources and the values match, then the data is provided a higher confidence assessment as the matching values are indicative of accurate and verifiable data. As another example, the credibility platform may collect objective data identifying first and second telephone numbers for a specific target entity. However, the first telephone number may be disconnected and the second telephone number may go to a different entity. In this example, the confidence assessment for the data will be poor even though the strength assessment may be good. As with the strength assessment, the confidence assessment can be reflected as part of the credibility assessment using some alphanumeric or symbolic representation. Accordingly, strength and confidence contribute to the holistic derivation of credibility.

The process also produces (at 170) comparative context to supplement the credibility data and entity-specific context. The comparative context provides a comparative point of reference by which the credibility of a target entity can be evaluated relative to a group of entities that is of interest. The process does so by first identifying user criteria defining entities and credibility that are of interest. The criteria can include identifying information of one or more entities, industry classifications, geographic identifiers, etc. The process then uses the objective data to dynamically link entities that satisfy the user provided criteria and to generate the comparative context from the subjective and objective data of the target entity and each of the dynamically linked entities. In this manner, the credibility platform orients the target entity's credibility relative to other entities of interest.

The process then generates a report or interface to present (at 180) the subjective data, objective data, entity-specific context, comparative context, or some combination thereof. In some embodiments, the report or interface is also supplemented with the credibility, strength, and confidence assessments. These assessments may be represented as different alphanumeric and/or symbolic representations. In some embodiments, access to the reports or the interfaces is sold as a tangible good or service of the credibility platform.

### II. Entity-Specific Context

The entity-specific context of some embodiments is a key differentiator that adds intelligence to the aggregated subjective and objective data. This intelligence stems from identifying and creating temporal and/or relational similarities between the subjective data and the objective data within the same entity record.

In some embodiments, the credibility platform creates entity-specific context from temporal similarities. Temporal similarities are present when timestamps or dates for two or more instances of subjective data and/or objective data are within the same period of time. The credibility platform identifies temporal relevance between the aggregated data in order to spot particular issues or events that impact the credibility of an entity. For instance, the credibility platform can gauge the impact that a new product release has on the credibility of the entity that releases the product based on the positive and negative sentiment that is expressed in the subjective data targeting the entity in the days following the release.

In some embodiments, the credibility platform creates entity-specific content from temporal similarities by organizing the aggregated subjective and objective data from an entity record to a timeline based on occurrence. To create the timeline, the credibility platform aggregates dates for each item of aggregated subjective and objective data. For the subjective data, the dates represent when the subjective data was created or published. For the objective data, the dates can correspond to when an event occurred. An event is any action or occurrence undertaken by or transpiring on the entity. For example, the objective data may include a first “remodeling” event with a first date, a second “new location opening” event with a second date, and a third “promotional sale” event with a third date. The credibility platform can also record dates for when previously recorded objective data is changed. Examples for some such changes include identifying changes to a menu, pricing, executive management, or address. To identify such changes, the credibility platform keeps a historic record of the aggregated data. As the credibility platform continually aggregates objective data, it compares the newly aggregated data with previously aggregated data. If no change or new data is detected, then nothing is recorded. If a change is detected, the credibility platform appends to the entity record by entering the new data to the entity record with a date while retaining the old data in the entity record with a prior date. If new data is detected, the new data is entered to the entity record with a date.

In some embodiments, the credibility platform creates entity-specific context based relational similarities in the objective data and the subjective data from a given entity record. This involves identifying subjective data and objective data from the same entity record that are directed to the same or similar subject matter, aspect, or offering of the target entity. In some embodiments, the credibility platform identifies these relational similarities by matching related words that appear within the subjective and objective data. As an example, an instance of subjective data reciting “the food is fantastic” can be linked to an instance of objective data identifying that a new head chef was hired. To increase the likelihood for identifying a proper relational association, the credibility platform may reference a dictionary of related words. Using the example above, the words “food” and “chef” would be related in the dictionary and that relation would be sufficient for creating the relational association between the different instances of subjective data and objective data.

It should be noted that the entity-specific context can be created from a combination of temporal similarities and relational similarities. Using both, the credibility platform can increase the likelihood of a correct association. Continuing from the example above, the subjective data reciting “the food is fantastic” would only be linked to the objective data identifying that a new chef was hired when the dates for the two items of credibility data are within three months of one another. Contextual association is present because the instance of subjective data at issue identifies food quality and the instance of objective data at issue identifies a new person in charge of food quality and temporal association is also present because the instance of subjective data is relevant in time to the instance of the objective data.

Entity-specific context is comprised of at least two instances of credibility data whether subjective data, objective data, or some combination thereof. However, it should be noted that entity-specific context can be comprised of many more instances of subjective data and/or credibility data. This is often the case when occurrence of specific objective data leads to several related instances of subjective data. Entity-specific context can also be chained such that one instance of entity-specific context leads to another instance of entity-specific context. The contextually associated data that yields the entity-specific context is referred to as contextual data.

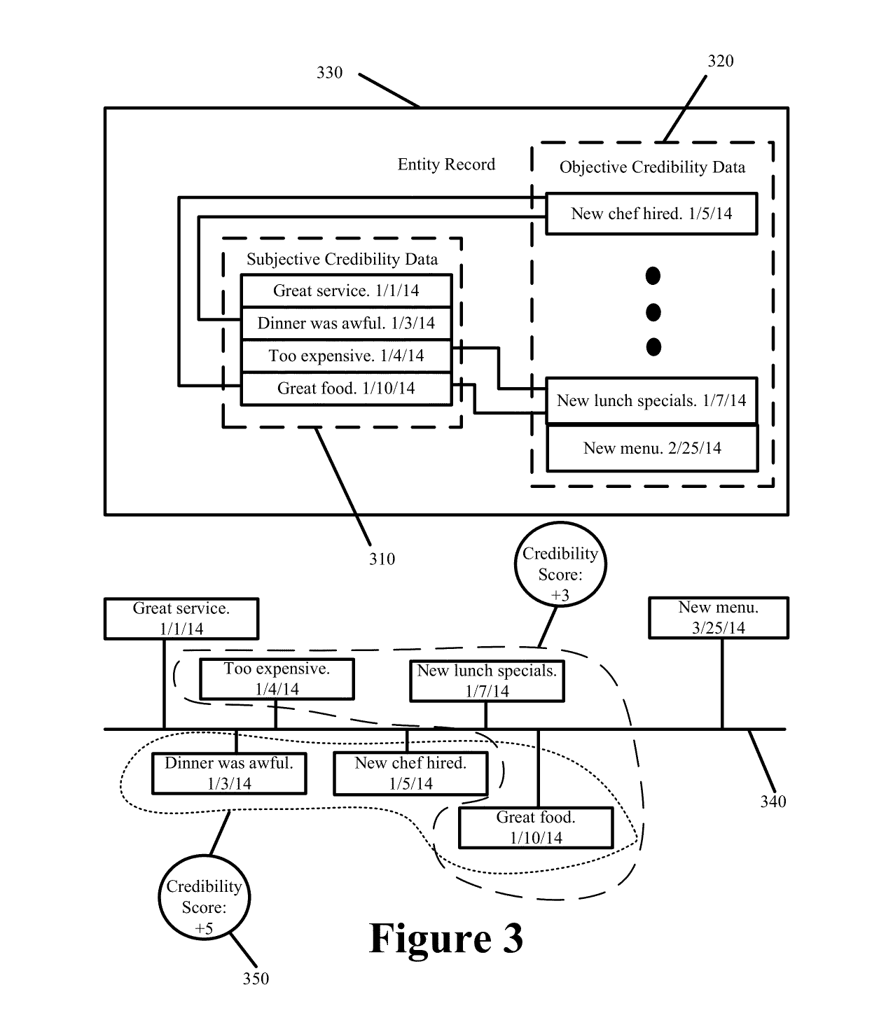

FIG. 3 conceptually illustrates creating entity-specific context from temporal and relational similarities in subjective and objective data in accordance with some embodiments. The figure depicts various subjective data 310 and objective data 320 that is aggregated to an entity record 330. A timestamp is associated with each instance of data. The credibility platform arranges the data based on their respective timestamps to a timeline 340. The organized data is then processed to identify and link related objective and subjective data. The linked data represents the contextual data of some embodiments.

In some embodiments, the contextual data or links that bring about the contextual data are stored back to the respective entity record. The credibility platform then uses the contextual data from the entity record when presenting the credibility of an entity. The entity-specific context facilitates the understanding of entity credibility because it identifies a specific casual effect or causal result. Causal effects identify instances where the objective data is the cause for the linked or associated subjective data. Causal results identify instances where the objective data is the result of the linked or associated subjective data. By automatically identifying these causal effects and causal results, the credibility platform not only identifies the credibility of a given entity, but also identifies what led to the increases or decreases in the entity credibility. The casual effects and results can also reveal if the entity has taken any actions in response to subjective data in order to remedy or improve its credibility.

In some embodiments, the credibility platform compartmentalizes the presentation of the entity credibility on the basis of contextual data. For example, when a user observes or selects subjective or objective data, the other contextually relevant data can be presented in conjunction therewith without the user having to draw the manually draw the connections.

To directly link the entity-specific context to the understanding of credibility, the credibility platform of some embodiments quantifies the entity-specific context's impact on credibility. Specifically, the credibility platform computes the positive or negative change that the contextual data has on the entity's overall credibility. This then provides a numeric measure from which the user can appreciate how much or how little of an impact certain subjective data and objective data has on an entity's credibility. With reference back to FIG. 3, reference marker 350 identifies the quantifications that some embodiments extract from the contextual data.

### III. Comparative Context

While subjective data, objective data, and contextual data improve the understanding of entity credibility, they do so with a focus on one entity. Some embodiments of the credibility platform supplement such information with comparative context. The comparative context presents credibility and other relevant information for a group of entities that includes a target entity. The comparative context completes the holistic presentation of entity credibility by orienting the credibility of the target entity relative to other entities of the group.

Comparative context cannot be obtained from current review and rating aggregation sites of the prior art because these sites treat each entity independently from one another. For instance, some prior art sites allow a user to search for restaurants that serve sushi in Atlanta, Ga. with the search results listing all restaurants that meet the search criteria. The search results can be ordered according to price or an average rating score. A user can then go about independently analyzing the credibility of each entity with no comparative context other than the listed entities are sushi restaurants in Atlanta. Critically lacking from these results is any information about the collective group. The user is unable to answer questions such as whether the sushi restaurants are successful relative to other restaurants in town, which of the sushi restaurants are relatively new, which ones operate with a higher volume of business, and is sushi popular in that geographic region relative to other regions. Here again, the credibility platform differentiates itself from the prior art by providing the comparative context necessary to answer these and other questions as part of the presentation of entity credibility.

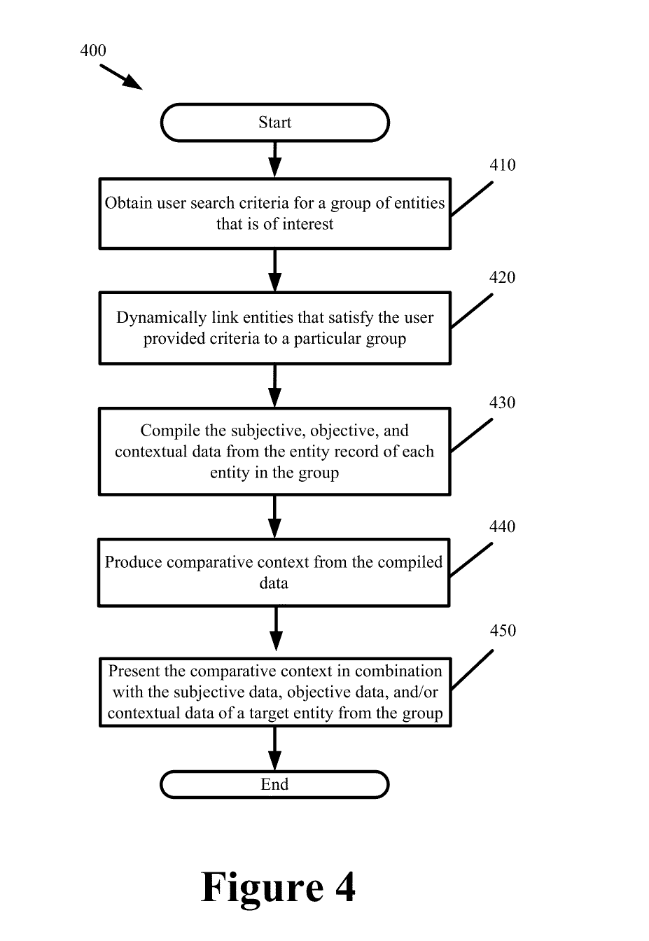

FIG. 4 presents a process 400 for creating comparative context to supplement entity credibility in accordance with some embodiments. The process 400 commences by obtaining (at 410) user search criteria for a group of entities that is of interest to the user. The search criteria can be based on any objective data that the credibility platform collects to the entity records. The search criteria can thus be formulated using any one or more of entity names, goods, services, geographic region, industry, sector, entity size, revenue, years in operation, etc. The geographic region of an entity is determined from objective data identifying the entity's location or contact information. In some embodiments, the sector or industry of an entity is determined from objective data identifying a Standard Industrial Classification (SIC) code, North American Industry Classification System (NAICS) code, or similar code and sub-codes representing operation of the entity.

The process dynamically links (at 420) entities that satisfy the user provided criteria to a particular group. The dynamic linking is performed by identifying the entity records that contain objective data satisfying the user provided search criteria.

Next, the process compiles (at 430) the subjective, objective, and contextual data from the entity record of each entity in the group. From the compiled data, the process produces (at 440) comparative context for the group. The process presents (at 450) the comparative context in combination with the subjective data, objective data, and/or contextual data of a target entity from the group. The comparative context can be changed by changing the criteria for the dynamically linked group of entities.

Producing the comparative context involves performing a statistical analysis of the subjective, objective, and contextual data of the group. The statistical analysis yields averages, aggregate values, and identifies trends from the data of the group. In other words, the comparative context yields collective metrics that are representative of the group as a whole. Some comparative context that the credibility platform produces based on the subjective data of a group of entities can include, for example, the average number of reviews that is aggregated for entities of the group, the average number of ratings that is aggregated for entities of the group, the average credibility for entities of the group, and the ratio of positive to negative subjective data for entities of the group. Some comparative context that the credibility platform produces based on the objective data of a group of entities can include, for example, the average number of employees, average revenue, and average years in business for the entities of the group. The comparative context that is produced is only limited by the subjective, objective, and contextual data that is available for the entities of the group.

The comparative context facilitates the holistic reporting of credibility by providing insight beyond the credibility of a target entity. The comparative context acts to orient the credibility of one target entity to a group of entities that is of interest. For example, a user can restrict the group to all entities that were established in the past year in a specific region and then compare the credibility of a target entity to the credibility of the group. Then, the user can change the search criteria to compare the credibility of the target entity to the credibility of another group that is comprised of entities in the same revenue range as the target entity. The comparative context thus allows users to focus the presentation of credibility to what matters to them. It also allows users to filter the presented credibility, and in so doing, rank the credibility of a target entity relative to a specific set of competitors. Moreover, in orienting the credibility of one target entity to a group of entities, the comparative context presents the credibility of one entity relative to others, and in so doing, explains circumstances explaining the derivation of the target entity's credibility. For instance, a first entity may have one hundred positive reviews and a second entity may only have ten positive reviews, making the first entity seem more credible than the second entity. However, the comparative context identifies that the first entity has three times the sales volume as the second entity, and therefore explains why the second entity has fewer reviews.

For more in-depth comparative context, the credibility platform of some embodiments generates the comparative context from current reference data and also from historic reference data. The reference data includes any combination of subjective data, objective data, and contextual data. The current reference data refers to the latest or most recent aggregated reference data, whereas the historic reference data refers to reference data that was aggregated over one or more intervals preceding that of the current reference data.

Metrics that are derived from the historic reference data are used to identify trends, fluctuations, and changes affecting the group as part of the comparative context. In other words, rather than present the average revenue for the group, the historic comparative context identifies how revenue for the group has changed over time, further revealing whether the group is expanding or shrinking.

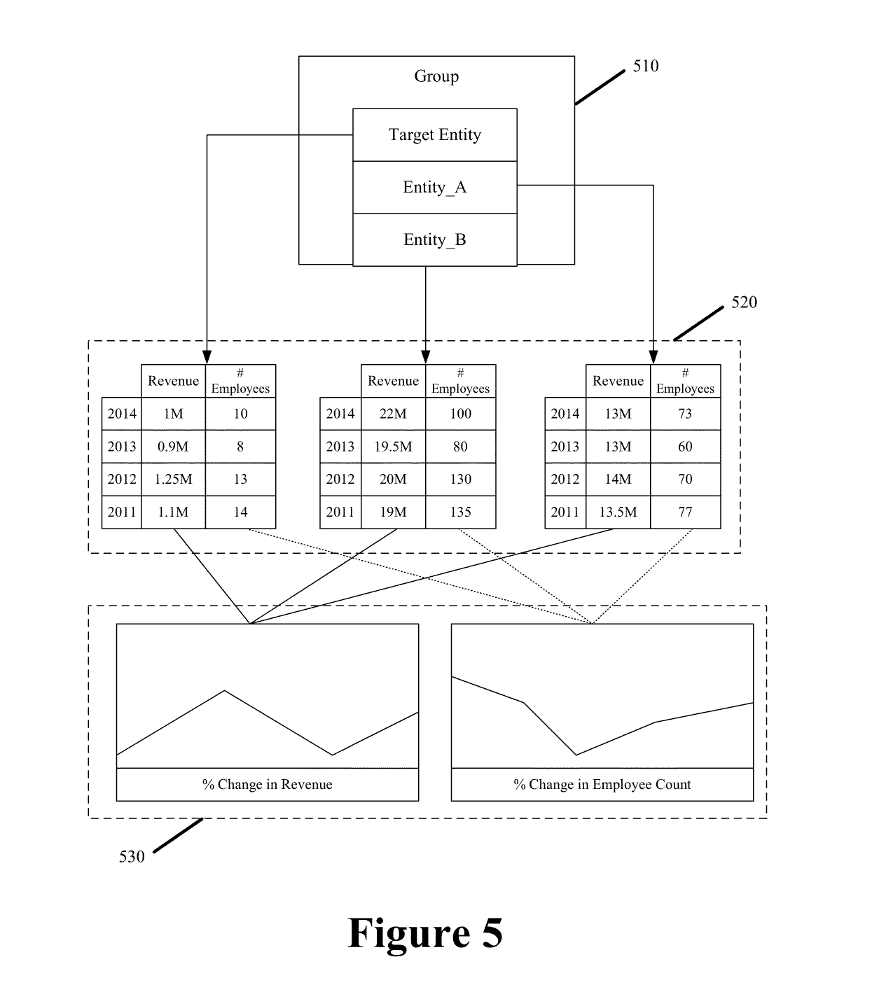

FIG. 5 conceptually illustrates generating comparative context from current and historic reference data of a group in accordance with some embodiments. First, the credibility platform dynamically links together a group of entities 510 based on user specified criteria. Next, the credibility platform retrieves the current and historic reference data 520 for each entity of the group from the corresponding entity records. The reference data is then processed to yield the comparative context 530 that is to be included as part of the holistic presentation of credibility. As before, the comparative context provides a statistical analysis for the group. However, in this case, each data point has different time values that are processed to identify how the data point for the collective group changes over the different time values.

In some embodiments, the credibility platform supplements the comparative context by generating comparative context for at least a first group of entities that includes a target entity and a second group of entities that includes entities that fall outside the first group because their objective data is at least one-off from the criteria of the first group. This provides context at the group level such that the target entity's group can be compared to other related groups. For example, a user may specify criteria for a first group comprising entities within the 90265 zip code and that operate as fine-dining restaurants. The credibility platform may then generate a second group to include entities that operate as fine-dining restaurants, but that are in the neighboring 90266 zip code and a third group to include entities within the 90265 zip code, but that operate as fast-food restaurants. The credibility platform would then generate comparative context for each group using the current and/or historic reference data from each entity in the respective groups. From this comparative context, a user can then see how a specific fine-dining restaurant in the 90265 zip code compares relative to other such restaurants in the same zip code, to other such restaurants in the neighboring zip code, and to fast-food restaurants in the same zip code.

### IV. Interfaces

Figures are now provided to demonstrate the holistic presentation of credibility that is provided by the credibility platform of some embodiments. These figures demonstrate the entity-specific context as well as the comparative context in accordance with some embodiments.

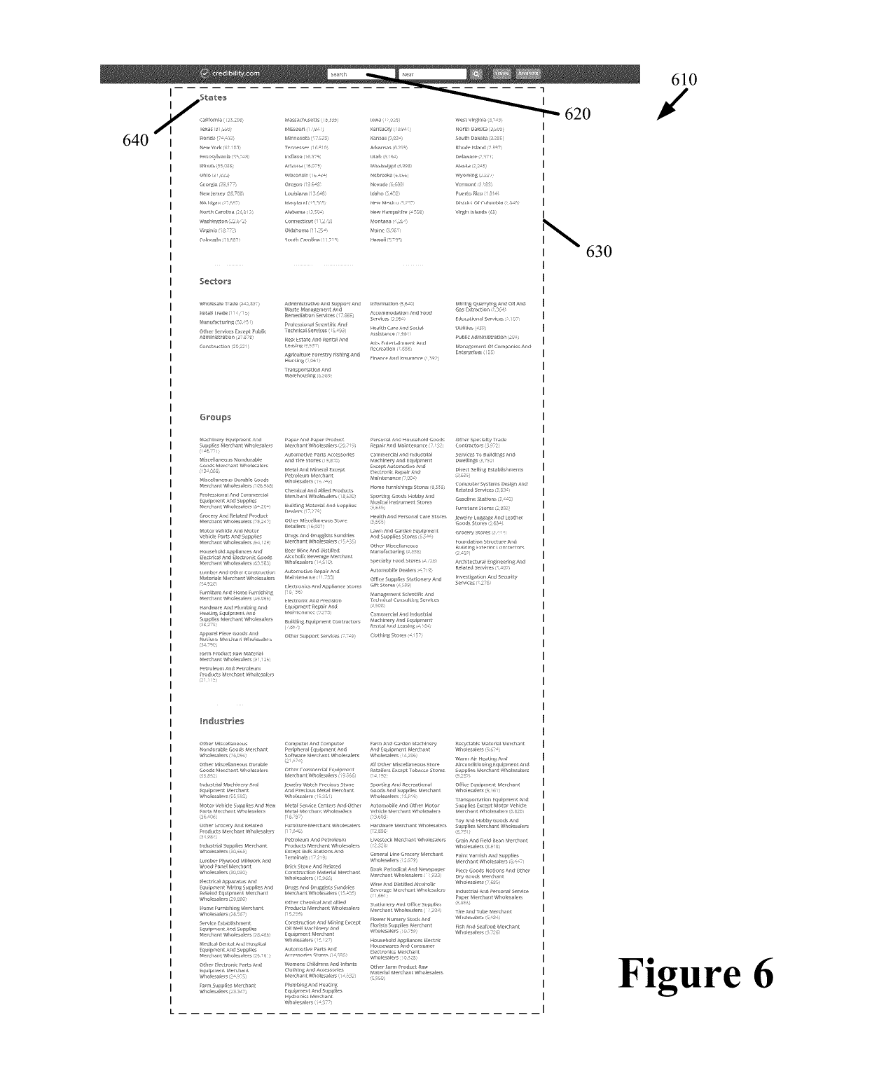

FIG. 6 provides an introductory interface 610 of the credibility platform. The interface 610 provides two ways with which a user can identify credibility for a target entity or group of entities that is of interest. First, the interface 610 includes a search field 620. Using the search field 620, the user can enter entity names, goods, services, geographic location, industry, or any other objective data that is available to the credibility platform in order to identify one or more entities that are of interest. The interface 610 also provides a set of predefined filters 630 relating to some set of the objective data that is available to the credibility platform. As illustrated, the set of predefined filters 630 includes filters for geographic region, sector, group, and industry. Selecting any of these filters leads to drill-down sub-filters. For instance, the geographic region filter 640 from the introductory interface 610 allows filtering by state. However, once a state is selected, the next presented interface lists various cities within the selected state with which to further filter the results. Similarly, if an industry filter is selected, the next presented interface lists various sub-industries with which the user can further restrict the matching set of entities meeting the user specified filter criteria. Each filter selection appends to earlier selections. In this manner, the user is able to select a combination of filters to identify entities of interest according to different objective data.

Once search or filtering criteria is provided, the credibility platform scans the entity records to identify the entity records that contain objective data matching the provided criteria. Then, the credibility platform generates a new interface to present the results.

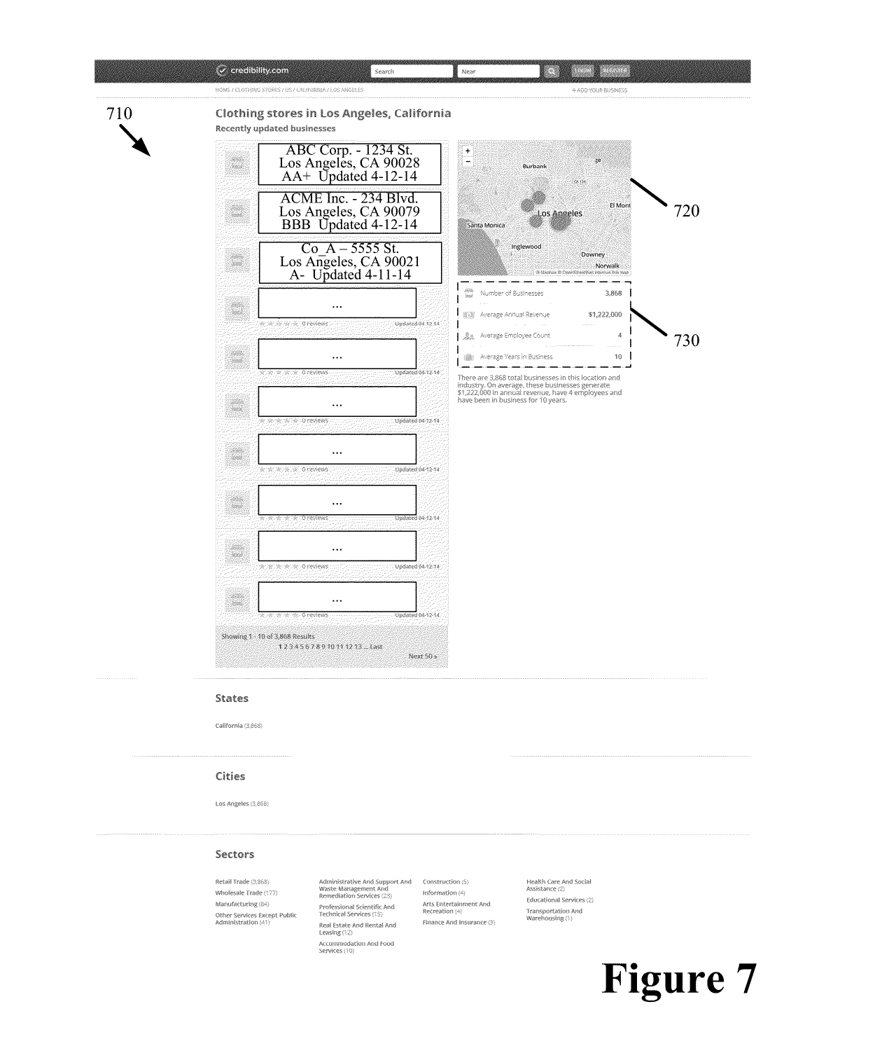

FIG. 7 illustrates an interface 710 that is presented in response to a user selection of a particular industry classification and geographic region. The interface 710 presents a set of entities that match the user specified criteria. Each entity is presented with basic objective data identifying the entity name and contact information and the credibility, strength, and confidence assessment for that entity. The credibility, strength, and confidence assessments are conveyed through a combined score. The combined score includes a letter from the A-F scale to indicate the credibility assessment, one to three letters to indicate the strength assessment, and a “+”, “−”, or absent symbol to indicate the confidence assessment. To differentiate from review aggregation sites of the prior art, the credibility platform also presents comparative context for the matching set of entities in panels 720 and 730.

Panel 720 maps the location of each presented entity relative to the other. This provides a first manner for orienting the credibility of one entity relative to others. Specifically, a user can quickly identify distances between the entities and determine whether it is worth the extra distance to reach a more credible entity than a lesser credible but closer entity. Panel 720 is derived by combining the objective location information for each entity of the set of entities on a single map.

Similarly, the comparative context presented in panel 730 is derived from the objective data of the matching set of entities. The comparative context of panel 730 is however derived using objective data relating to the financial and historic information of the set of entities. Thus to differentiate from the credibility presentation provided by the prior art, panel 730 presents the total number of entities within the group, their average annual revenue, average employee count, and average years in business. This is merely a sampling of the comparative context that can be derived from the objective data of the set of entities and presented through an interface that is similar to that of interface 710.

These interfaces and, more specifically, their comparative context can be used to extract or produce various reports and analytics that go beyond the credibility of any one entity or set of entities. By changing one item of the search criteria and comparing the comparative context presented in the newly resulting interface to that of the previously presented interface, a user can obtain higher level understanding of credibility. For example, interface 710 of FIG. 7 presents comparative context for clothing stores in Los Angeles, Calif. The comparative context identifies that there are 3,868 such entities with average annual revenue of $1,222,000, four employees, and an average of ten years in operation. The user can then change the geographic region filter to specify San Francisco, Calif. and compare if there are more or fewer clothing stores, if the clothing stores are generating more revenue on average in San Francisco than in Los Angeles, and if the stores employ more people. As another example, a user can modify search criteria of the credibility platform in order to identify where the technology industry is most concentrated and thriving by changing search criteria until the user finds the region with the most entities in the technology industry or with the highest average revenues. Such analytics are simply not available from the credibility sites of the prior art that lack the comparative context that is generated and presented by the credibility platform. These analytics can be used to generate reports about which regions or industries are thriving and which ones are stagnant or in decline. In this manner, the credibility platform is not only able to present credibility for an entity or a set of entities, but also holistically identify the meaning of that credibility in broader context.

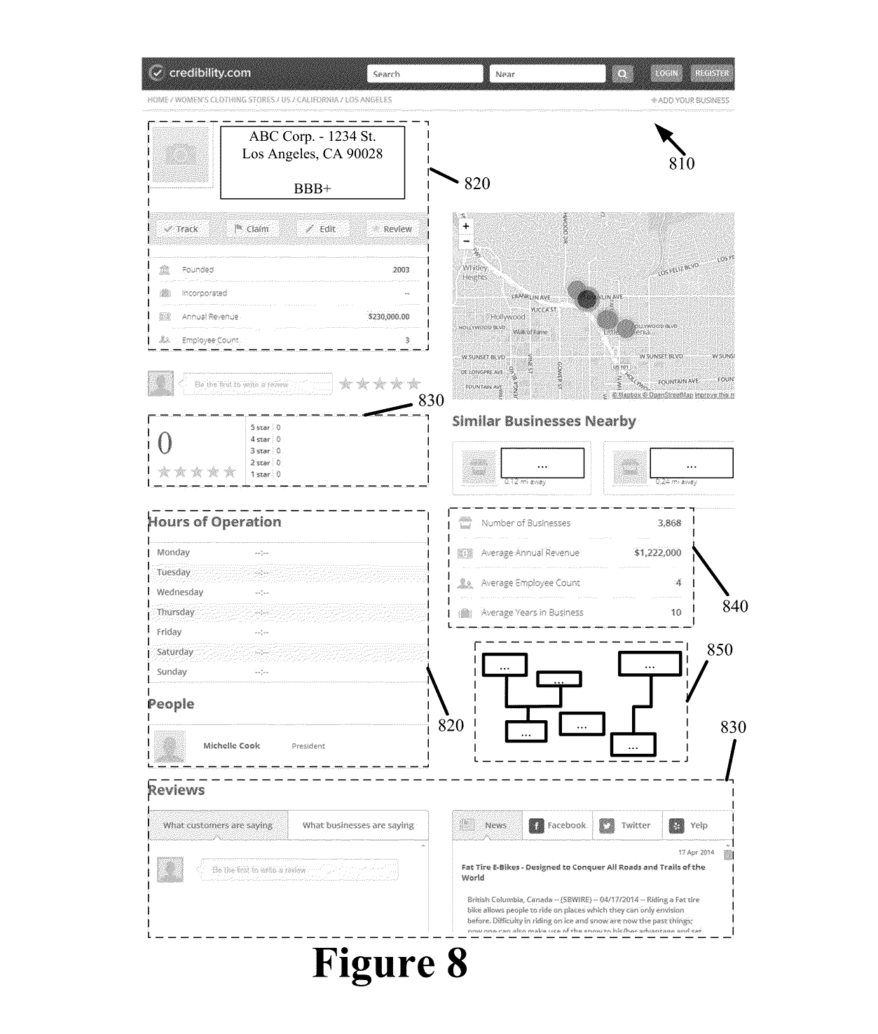

Entity-specific context is presented along with comparative context, subjective data, objective data, credibility assessment, strength assessment, and confidence assessment of a particular entity when the user selects the particular entity from interface 710, a similar interface presenting a set of entities, or when the particular entity is identified directly by search criteria. FIG. 8 illustrates an interface 810 provided by the credibility platform for holistically presenting the credibility of a particular target entity.

Interface 810 includes panels 820, 830, 840, and 850. Panel 820 provides the objective data for the target entity. As shown, this objective data can include data about the operation, identification, and performance of the target entity. Some of the data about the operation of the target entity includes identifying the entity's hours of operation. Some of the data about the identification of the target entity includes identifying the entity's name and contact information. Some of the data about the performance of the target entity includes identifying the entity's financial performance (i.e., revenue) and historic performance, such as the number of years it has been in operation. Panel 820 also presents the score conveying the credibility, strength, and confidence assessments.

Panel 830 provides the subjective data for the target entity. This panel summarizes the reviews and ratings that have been compiled for the target entity. This data can be presented through various scores or other quantifications. Additionally, a subset of the actual aggregated subjective data may be presented in the form of actual third party reviews and ratings that are directed to the target entity.

Panel 840 presents the comparative context. This context is derived based on other entities that are related to the target entity. The other entities can be identified from prior user search criteria or from nearby entities that are similar in one or more aspects to the target entity. Comparing the objective data from panel 820 and the comparative context from panel 840 reveals whether the target entity is a relatively new business, if the target entity is successful relative to its competition, and if the target entity is larger in size than its competition. These are all secondary considerations that may impact a user's decision in deciding which of two similar entities to engage with when the two entities have similar credibility or even different credibility. For example, a user may prefer a small business entity over a large business entity even when the large business entity has better credibility than the small business entity. Such comparative context is simply not available from credibility review sites of the prior art.

Panel 850 provides the entity-specific context. In some embodiments, the entity-specific context identifies temporal and relational similarities between two or more instances of objective and/or subjective data. In some embodiments, the entity-specific context is presented by highlighting certain keywords, reviews, or data. In some embodiments, the contextual data is presented in a drill-down or linked fashion, whereby selection of a specific instance of objective or subjective data will present one or more other instances of subjective or objective data that is temporally or relationally related.

### V. Engagement

Credibility is a continually evolving metric. Leading this change is the continual submission of subjective data by third parties. However, the number of submissions increases and decreases with the relevance of the target entity. To maintain its relevance, the target entity must itself evolve by changing its operation, identification, and performance (i.e., objective data) in response to issues that are identified in the third party subjective data submissions. If the target entity does not respond in kind, the third party interest in the target entity will begin to wane, leading to fewer subjective data submissions and stale credibility, which in turn causes other third parties to look somewhere other than the target entity for their needs.

Accurate credibility is therefore heavily based on cause and effect. The cause can be an action that is performed by the target entity and the effect can be the subjective data that third parties submit in response to the action. Alternatively, the cause can be one or more issues of the target entity that are identified in the subjective data submitted by the third parties and the effect can be one or more actions performed by the target entity in response to those issues, wherein the actions represent changes that the target entity makes to its operation, identification, or performance. It should therefore be evident that the engagement of the target entity is essential in order to accurately derive and measure credibility.

Many social media sites, online review sites, and rating aggregation sites exclude or fail to encourage engagement of the target entity. These sites derive credibility primarily based on the subjective data that is aggregated from third parties without input from the target entity. Consequently, credibility from these sites is missing at least one aspect of the cause and effect.

The credibility platform provides a more holistic derivation of credibility by offering several means with which the target entity, editors, and other third parties can contribute to the target entity's credibility and by providing several incentives to encourage such participation. In some embodiments, the credibility platform encourages such participation by prioritizing the presentation of credibility on the basis of the target entity's engagement. For example, the more engagement that a particular target entity receives, the more likely that the target entity's credibility will be presented earlier in search results relative to other entities that have fewer or less recent contributions.

In some embodiments, entity engagement is determined based on the number of objective and subjective data updates or contributions to an entity record and the recency of those updates or contributions. Accordingly, entities will want to participate and provide credibility data to the credibility platform in order to increase the number and recency of updates or contributions, thereby improving their ranking and receiving greater exposure as a result. As the target entities are a valuable source of credibility data and a primary means to produce change in their respective credibility, their active engagement serves to keep the credibility platform up-to-date and accurate. Moreover, the more engaged the targeted entities are, the faster they can address issues that are identified in the subjective data, thereby improving their own credibility.

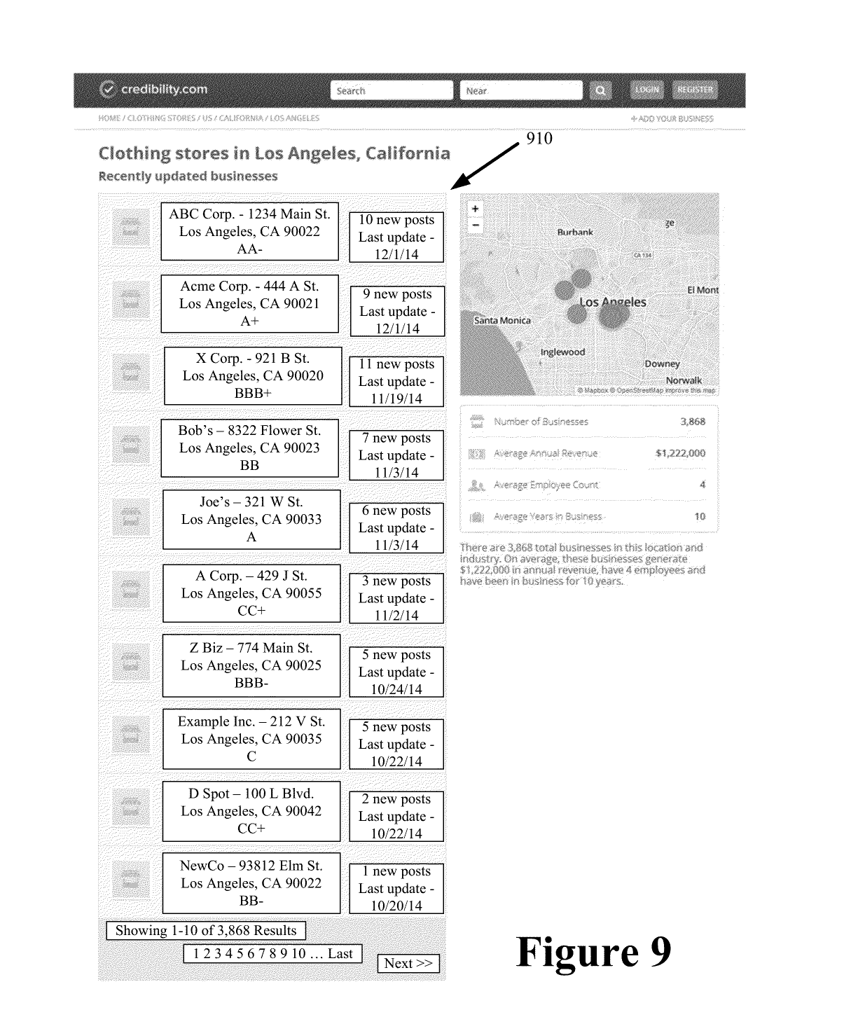

FIG. 9 presents an interface 910 illustrating the prioritized presentation of credibility based on entity engagement in accordance with some embodiments. The interface 910 presents summarized credibility for a set of entities that meet user specified criteria. However, rather than order the set of entities according to how well they match the user specified criteria, interface 910 orders the set of entities according to which entity has the greatest number of and most recent aggregated subjective and objective data. In other words, interface 910 orders the set of entities based on their engagement. Consequently, entities that have the most updated data are presented first.

In some embodiments, the credibility platform encourages entity participation by alerting target entities when new subjective or objective data is aggregated for the target entity or when a change is detected to existing data of the target entity. In order to benefit from the alerts, a target entity registers with the credibility platform and sets the alerts that it wishes to receive. Thereafter, the credibility platform monitors the entity record for that target entity in order to determine when one or more alerts are triggered. Also, when the target entity pulls up the interface containing the new or changed data, the credibility platform may highlight or otherwise distinguish the new or changed data to help orient the entity.

In some embodiments, the credibility platform encourages entity participation by providing fixed links or Uniform Resource Locators (URLs) to the interfaces presenting credibility for the different entities. The fixed links allow search engines to crawl and index the interfaces. This in turn creates greater exposure to the interface by directing more user traffic to the credibility of the target entity when a user searches for the target entity using a search engine. As a result, the credibility of the target entity becomes increasingly scrutinized and the target entity becomes more involved in order to ensure its credibility is positive. The fixed links are specified using a fixed format. Each link to a target entity's credibility interface first includes the domain name of the credibility platform. The path is then divided in multiple sub-paths. Each sub-path specifies an item of objective data that identifies the target entity, such as the target entity's industry, sector, and geographic region. The URL www.credibility.com/limitedservice-restaurants/US-IL-Lansing/AcmeCorp is a fixed link to the credibility interface of Acme Corp. The fixed link includes a first sub-path identifying the industry of Acme Corp. as a restaurant and the sub-industry as a limited service restaurant. The fixed link also includes a second sub-path identifying the geographic region of Acme Corp. to be in the state of Illinois and in the city of Lansing. In this manner, each target entity of the credibility platform is uniquely identified with a static address that can be crawled and searched by search engines and can be included within the search engine results.

The credibility platform facilitates entity engagement in a variety of ways. FIG. 8 illustrates a credibility interface for a target entity and various engagement options with which an entity can contribute thereto. The engagement options allow one to track, claim, edit, and review the profile.

Tracking allows an entity to be notified when a change is detected to the profile. The notifications can be customized to trigger upon specific changes such as when new subjective data is aggregated or when specific items of the objective data change. The notifications keep the target entity engaged by informing the target entity of any issues that the third parties identify in the subjective data and by allowing the target entity to take corrective action soon thereafter.

Claiming allows an entity to take ownership of the profile. In so doing, the entity can control what data is displayed on the profile and can further contribute data to be included as part of the profile and the credibility presentation. This offers the greatest level of engagement as the entity can customize the profile.

Editing allows submissions to the objective data for that entity profile. The entity can change data such as images, contact information, listing of agents, financial and historic information, etc. The entity can also provide links that the credibility platform can then use to aggregate new subjective and objective data into the interface.

Reviewing allows submissions to the subjective data for that entity profile. Third party can use the review option to submit reviews about the target entity.

The credibility platform logs all edits to the credibility of an entity. The credibility platform logs not only the change or addition, but the entity making the change or addition. This logging reduces the potential of defamation and fraud, whereby fake data is submitted for the purpose of improperly increasing or decreasing one's credibility. Using these logs, an administrator or target entity can remove or revert data that is submitted for these and other nefarious purposes.

VI. Computer System

Many of the above-described processes and components are implemented as software processes that are specified as a set of instructions recorded on a non-transitory computer-readable storage medium (also referred to as computer-readable medium). When these instructions are executed by one or more computational element(s) (such as processors or other computational elements like ASICs and FPGAs), they cause the computational element(s) to perform the actions indicated in the instructions, thereby transforming a general purpose computer to a specialized machine implementing the methodologies and systems described above. Computer and computer system are meant in their broadest sense, and can include any electronic device with a processor including cellular telephones, smartphones, portable digital assistants, tablet devices, laptops, desktops, and servers. Examples of computer-readable media include, but are not limited to, CD-ROMs, flash drives, RAM chips, hard drives, EPROMs, etc.

FIG. 10 illustrates a computer system with which some embodiments are implemented. Such a computer system includes various types of computer-readable mediums and interfaces for various other types of computer-readable mediums that implement the various processes, modules, and systems described above (e.g., credibility platform). Computer system 1000 includes a bus 1005, a processor 1010, a system memory 1015, a read-only memory 1020, a permanent storage device 1025, input devices 1030, and output devices 1035.

The bus 1005 collectively represents all system, peripheral, and chipset buses that communicatively connect the numerous internal devices of the computer system 1000. For instance, the bus 1005 communicatively connects the processor 1010 with the read-only memory 1020, the system memory 1015, and the permanent storage device 1025. From these various memory units, the processor 1010 retrieves instructions to execute and data to process in order to execute the processes of the invention. The processor 1010 is a processing device such as a central processing unit, integrated circuit, graphical processing unit, etc.

The read-only-memory (ROM) 1020 stores static data and instructions that are needed by the processor 1010 and other modules of the computer system. The permanent storage device 1025, on the other hand, is a read-and-write memory device. This device is a non-volatile memory unit that stores instructions and data even when the computer system 1000 is off. Some embodiments of the invention use a mass-storage device (such as a magnetic or optical disk and its corresponding disk drive) as the permanent storage device 1025.

Other embodiments use a removable storage device (such as a flash drive) as the permanent storage device Like the permanent storage device 1025, the system memory 1015 is a read-and-write memory device. However, unlike the storage device 1025, the system memory is a volatile read-and-write memory, such as random access memory (RAM). The system memory stores some of the instructions and data that the processor needs at runtime. In some embodiments, the processes are stored in the system memory 1015, the permanent storage device 1025, and/or the read-only memory 1020.

The bus 1005 also connects to the input and output devices 1030 and 1035. The input devices enable the user to communicate information and select commands to the computer system. The input devices 1030 include any of a capacitive touchscreen, resistive touchscreen, any other touchscreen technology, a trackpad that is part of the computing system 1000 or attached as a peripheral, a set of touch sensitive buttons or touch sensitive keys that are used to provide inputs to the computing system 1000, or any other touch sensing hardware that detects multiple touches and that is coupled to the computing system 1000 or is attached as a peripheral. The input devices 1030 also include alphanumeric keypads (including physical keyboards and touchscreen keyboards), pointing devices (also called “cursor control devices”). The input devices 1030 also include audio input devices (e.g., microphones, MIDI musical instruments, etc.). The output devices 1035 display images generated by the computer system. The output devices include printers and display devices, such as cathode ray tubes (CRT) or liquid crystal displays (LCD).

Finally, as shown in FIG. 10, bus 1005 also couples computer 1000 to a network 1065 through a network adapter (not shown). In this manner, the computer can be a part of a network of computers such as a local area network (“LAN”), a wide area network (“WAN”), or an Intranet, or a network of networks, such as the internet. For example, the computer 1000 may be coupled to a web server (network 1065) so that a web browser executing on the computer 1000 can interact with the web server as a user interacts with a GUI that operates in the web browser.

As mentioned above, the computer system 1000 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable blu-ray discs, and any other optical or magnetic media.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method comprising:
with at least one machine comprising a processor:
aggregating for an entity, (i) a plurality of objective data relating to any of entity operation, identification, and performance and (ii) a plurality of subjective data comprising sentiment that third parties direct to any of the entity operation, identification, and performance;
linking a particular instance of subjective data with a particular instance of objective data relating to the same one of entity operation, identification, and performance;
providing a holistic presentation of the entity credibility by presenting the plurality of subjective data, the plurality of objective data, and a contextual link identifying a relation between the particular instance of the subjective data and the particular instance of the objective data.

2. The method of claim 1 further comprising identifying a group of entities having aggregated objective data that matches objective data provided as part of user search criteria, wherein said entity is within the group of entities.

3. The method of claim 2 further comprising deriving a set of metrics identifying collective credibility of the group of entities from at least one of objective data and subjective data of each entity of the group of entities.

4. The method of claim 3, wherein providing the holistic presentation comprises presenting the set of metrics identifying collective credibility of the group of entities with the plurality of subjective data, the plurality of objective data, and the contextual link.

5. The method of claim 1, wherein linking the particular instance of subjective data with the particular instance of objective data comprises linking when the particular instance of subjective data comprises a first timestamp, the particular instance of objective data comprises a second timestamp, and the first timestamp is within a time threshold of the second timestamp.

6. The method of claim 1, wherein linking the particular instance of subjective data with the particular instance of objective data comprises identifying a temporal association between the particular instance of subjective data and the particular instance of objective data.

7. The method of claim 1, wherein linking the particular instance of subjective data with the particular instance of objective data comprises identifying a relational association whereby the particular instance of subjective data is directed to the same matter as the particular instance of objective data.

8. A method comprising:
with at least one machine comprising a processor:
aggregating for each of a plurality of entities, (i) a plurality of objective data identifying changes to any of entity operation, identification, and performance and (ii) a plurality of subjective data comprising sentiment that third parties direct to any of the entity operation, identification, and performance;
identifying a subset of the plurality of entities that meet user specified criteria;
generating collective metrics based on the plurality of objective data of the subset of entities; and
providing a holistic presentation of credibility for the subset of entities by presenting a listing of each of the subset of entities, a set of subjective data and objective data for each entity in said listing, and the collective metrics.

9. The method of claim 8 further comprising ordering the subset of entities according to engagement of each entity in the subset of entities, wherein the engagement of each entity is determined from at least one of a number of aggregated data and recency of the aggregated data.

10. The method of claim 8 further comprising providing a holistic presentation of credibility for a specific entity that is selected from said listing by presenting for the specific entity, (i) the plurality of objective data including size and financial performance of the specific entity and (ii) the plurality of subjective data aggregated for the specific entity.

11. The method of claim 10 further comprising generating entity-specific context for the specific entity by identifying at least one of a temporal and relational association between a first instance of either the subjective data and the objective data that is aggregated for the specific entity and a second different instance of either the subjective data and the objective data that is aggregated for the specific entity, wherein the temporal association involves the first instance being associated with the second instance based on time, wherein the relational association involves the first instance identifying the same matter as the second instance, and wherein providing the holistic presentation of credibility for the specific entity further comprises presenting the entity-specific context for the specific entity.

12. The method of claim 8 further comprising providing context for the plurality of objective data by identifying a location of each entity in the listing on a map, wherein the location of each entity is determined from the plurality of objective data.

13. The method of claim 8 further comprising deriving a sector classification with which to filter the subset of entities, wherein deriving the sector classification is based on at least one of Standard Industrial Classification (SIC) codes and North American Industry Classification System (NAICS) codes from the plurality of objective data.

14. The method of claim 13 further comprising deriving a geographic classification with which to filter the subset of entities according to a geographic region, wherein deriving the geographic classification is based on entity location stored as part of the plurality of objective data.

15. The method of claim 8, wherein providing the holistic presentation of credibility comprises ordering the subset of entities according to most recent objective or subjective data that is aggregated for each entity and presenting the listing based on said ordering.

16. The method of claim 8, wherein the collective metrics specify at least one of average revenue, average employee count, and average years in business for the subset of entities.

17. A computer system comprising:
a memory storing computer-executable instructions; and
a computer processor in communication with the memory, the computer-executable instructions programming the computer processor in:
aggregating for an entity, (i) a plurality of objective data relating to any of entity operation, identification, and performance and (ii) a plurality of subjective data comprising sentiment that third parties direct to any of the entity operation, identification, and performance;
linking a particular instance of subjective data with a particular instance of objective data relating to the same entity operation, identification, and performance;
providing a holistic presentation of the entity credibility by presenting the plurality of subjective data, the plurality of objective data, and a contextual link identifying a relation between the particular instance of the subjective data and the particular instance of the objective data.

18. The computer system of claim 17, wherein the computer-executable instructions further program the computer processor in identifying a group of entities having aggregated objective data that matches objective data provided as part of user search criteria, wherein said entity is within the group of entities.

19. The computer system of claim 18, wherein the computer-executable instructions further program the computer processor in deriving a set of metrics identifying collective performance of the group of entities from at least one of objective data and subjective data of each entity of the group of entities.

20. The computer system of claim 19, wherein providing the holistic presentation comprises presenting the set of metrics identifying collective performance of the group of entities with the plurality of subjective data, the plurality of objective data, and the contextual link.
